(19) United States
(12) Patent Application Publication
(10) Pub. No.: US 2026/0029601 A1
(43) Pub. Date: Jan. 29, 2026

(54) OPTICAL CABLE

(71) Applicant: SUMITOMO ELECTRIC INDUSTRIES, LTD., Osaka (JP)

(72) Inventors: Ryota FUKUMOTO, Osaka (JP); Nayu YANAGAWA, Osaka (JP); Taro FUJITA, Osaka (JP); Fumiaki SATO, Osaka (JP); Yohei SUZUKI, Osaka (JP)

(21) Appl. No.: 18/994,168

(22) PCT Filed: Jul. 6, 2023
(86) PCT No.: PCT/JP2023/025139

§ 371 Date: Jan. 14, 2025

(30) Foreign Application Priority Data
Aug. 3, 2022 (JP) 2022-124332

(51) Int. Cl. G02B 6/44

(52) U.S. Cl. CPC G02B 6/443

(57) ABSTRACT

The optical cable according to an embodiment of the present disclosure is for laying thereof in a microduct, the optical cable being provided with an assembly core that accommodates one or more optical fiber cores, and a sheath layer that covers an outer periphery of the assembly core, the density of the sheath layer being 1.0 g/cm³ or less, a main component of the sheath layer being polyethylene, the sheath layer containing silicone, the density of the polyethylene being 0.92 g/cm³ or greater, the weight-average molecular weight of the silicone being 50,000-1,000,000, and the content ratio of the silicone in the sheath layer being 0.5-10 mass %.

### TECHNICAL FIELD

The present disclosure relates to an optical cable. This application claims priority based on Japanese Patent Application No. 2022-124332 filed on Aug. 3, 2022, the entire contents of which are incorporated herein by reference.

### BACKGROUND ART

The construction of optical networks is progressing in order to support two-way communication and high volume communication in addition to an increase in the speed of communication and an increase in the volume of information due to the widespread use of information and communication technologies such as the Internet. In the optical networks, Fiber To The Home (FTTH) has started in which a communications carrier and each home are directly connected to each other through an optical fiber to provide high-speed communication services, and the volume of communication has increased each year. Accordingly, a decrease in the diameter and an increase in the density of an optical cable have been desired. For example, Patent literature 1 (Japanese Unexamined Patent Application Publication No. 2010-8923) discloses the structure of an optical cable referred to as a so-called slotless type.

### CITATION LIST

### Patent Literature

Patent literature 1: Japanese Unexamined Patent Application Publication No. 2010-8923

### SUMMARY OF INVENTION

An optical cable according to an aspect of the present disclosure is an optical cable for installation in a microduct. The optical cable includes an assembled core containing one or more optical-fiber core wires, and a sheath layer covering an outer periphery of the assembled core. The sheath layer has a density of 1.0 g/cm³ or less. A main component of the sheath layer is polyethylene. The sheath layer contains silicone. The polyethylene has a density of 0.92 g/cm³ or greater. The silicone has a weight-average molecular weight of 50,000 to 1,000,000. A content ratio of the silicone in the sheath layer is 0.5% by mass to 10% by mass.

### BRIEF DESCRIPTION OF THE DRAWINGS

FIG. 1 is a schematic sectional view of an optical cable according to an embodiment of the present disclosure.

FIG. 2 is a schematic view of a blowing equipment used for a microduct blowing test.

FIG. 3 is a schematic sectional view of an optical cable according to another embodiment of the present disclosure.

FIG. 4 is a diagram illustrating an example of an intermittently adhered optical fiber ribbon contained in an optical cable.

### DETAILED DESCRIPTION

### Problems to be Solved by Present Disclosure

A construction method in which a cable is fed, by air blowing, into a microduct that is a tubular duct with a small diameter is referred to as a microduct system construction method. The microduct system construction method enables rapid additional installation of optical fibers necessary for the growth of the optical networks as described above and is a very effective method of realizing FTTH. Thus, it is desirable to provide an optical cable suitable for the application of the microduct system construction method, in particular, in the access/drop area.

As described above, the slot-less optical cable is easily reduced in weight and thus is suitable for an air-blown optical cable (also referred to as a microduct cable). Such an air-blown optical cable is caused to pass into a small-diameter duct while air at a predetermined pressure is supplied into the duct and the cable is pushed. Thus, it is desirable to make it easy for the optical cable to pass through the duct. In particular, since the installation cost can be further reduced with an increase in the blowing distance, an air-blowing property for a long distance is desired.

The present disclosure has been made in view of the above circumstances, and an object of the present disclosure is to provide an optical cable having an excellent air-blowing performance into a microduct.

### Advantageous Effects of Present Disclosure

The optical cable of the present disclosure has an excellent air-blowing performance into a microduct.

### Description of Embodiments of Present Disclosure

First, embodiments of the present disclosure will be listed and described.

An optical cable according to an aspect of the present disclosure is an optical cable for installation in a microduct. The optical cable includes an assembled core containing one or more optical-fiber core wires, and a sheath layer covering an outer periphery of the assembled core. The sheath layer has a density of 1.0 g/cm³ or less. A main component of the sheath layer is polyethylene. The sheath layer contains silicone. The polyethylene has a density of 0.92 g/cm³ or greater. The silicone has a weight-average molecular weight of 50,000 to 1,000,000. A content ratio of the silicone in the sheath layer is 0.5% by mass to 10% by mass.

Furthermore, an optical cable according to another aspect of the present disclosure is an optical cable for installation in a microduct. The optical cable includes an assembled core containing one or more optical-fiber core wires, and a sheath layer covering an outer periphery of the assembled core. The sheath layer has a density of 1.0 g/cm³ or less. A main component of the sheath layer is polyethylene. The sheath layer contains silicone. The polyethylene has a density of 0.92 g/cm³ or greater. The silicone has a weight-average molecular weight of 50,000 to 1,000,000. A content ratio of the silicone in the sheath layer is 0.5% by mass to 10% by mass. The one or more optical-fiber core wires are each an intermittently adhered optical fiber ribbon.

Since the sheath layer of the optical cable used for installation in a microduct has a density of 1.0 g/cm³ or less, the optical cable can be reduced in weight. In addition, since the sheath layer contains polyethylene having a density of 0.92 g/cm³ or greater as a main component, the optical cable can have a good hardness. As a result, the optical cable is easily fed during air blowing into the microduct. Moreover, since the content ratio of the silicone having a weight-average molecular weight of 50,000 to 1,000,000 in the sheath layer is 0.5% by mass to 10% by mass, slidability of the surface of the sheath layer and thus the air-blowing property during air blowing are improved. The optical cable can have a good air-blowing performance into the microducts due to improvements in the hardness of the sheath layer, the slidability of the surface of the sheath layer, and the reduction in weight of the sheath layer. Here, the “main component” refers to a component having the highest content ratio among the components, and preferably refers to a component having a content ratio of more than 50% by mass.

The “weight-average molecular weight” is a value measured by a gel permeation chromatography (GPC) method in terms of standard polystyrene. Specifically, the average molecular weight is determined under the following conditions using tetrahydrofuran as a solvent, with a GPC system (SC-8010 manufactured by Tosoh Corporation), using a calibration curve prepared with commercially available standard polystyrene samples.
Flow rate: 1.0 ml/min
Set temperature: 40° C.
Column structure: “TSK guardcolumn MP (XL)” manufactured by Tosoh Corporation, 6.0 mm ID×4.0 cm, 1 column, and “TSK-GELMULTIPOREHXL-M” manufactured by Tosoh Corporation, 7.8 mm ID×30.0 cm (theoretical plate number: 16,000), 2 columns, 3 columns in total (theoretical plate number as a whole: 32,000)
Sample Amount of sample injected: 100 μl (concentration of sample solution: 1 mg/ml)
Liquid feeding pressure: 39 kg/cm²
Detector: RI detector

The sheath layer may have an elastic modulus E1 of 250 MPa to 2000 MPa at 25° C. When the sheath layer has an elastic modulus E1 of 250 MPa to 2000 MPa at 25° C., the sheath layer can have a hardness in a favorable range, and thus the optical cable can have a further improved air-blowing performance into a microduct. The “elastic modulus” is a value measured in accordance with the test method of dynamic mechanical properties described in JIS-K7244-4 (1999) and is a value of a storage elastic modulus measured with a viscoelasticity measuring device (for example, “DVA-220” manufactured by IT Keisoku Seigyo Co., Ltd.) in a tensile mode, in a temperature range of −60° C. to 80° C., at a temperature increasing rate of 5° C./min, at a frequency of 10 Hz, and at a strain of 0.05%.

The sheath layer may have an elastic modulus E2 of 30 MPa or greater at 70° C. When the sheath layer has an elastic modulus E2 of 30 MPa or greater at 70° C., a deformation of the cable can be suppressed during the storage at a high temperature.

A product C1×E3 of a linear expansion coefficient C1 of the sheath layer in a temperature range of −30° C. to 70° C. and an elastic modulus E3 of the sheath layer at −30° C. may be 0.35 [MPa/K] or less. In the optical cable, the product of the linear expansion coefficient of the sheath layer and the elastic modulus at a low temperature is set to the above range, and thus it is possible to improve the effect of suppressing an increase in transmission loss due to expansion and contraction of the sheath layer after heat cycles. This mechanism is that either or both of the linear expansion coefficient, and the elastic modulus at a low temperature and room temperature or higher are relatively small, and thus the stress of the sheath layer to contract at a low temperature is suppressed, and the increase in transmission loss due to the contraction can be suppressed. The “linear expansion coefficient” is a linear expansion ratio measured in accordance with the test method of dynamic mechanical properties described in JIS-K7244-4 (1999), and is a value calculated from a dimensional change of a thin sheet with respect to a temperature change using a viscoelasticity measuring device (for example, “DVA-220” manufactured by IT Keisoku Seigyo Co., Ltd.) in a tensile mode, in a temperature range of −60° C. to 80° C., at a temperature increasing rate of 5° C./min, at a frequency 10 Hz, and at a strain of 0.05%.

The polyethylene may be a high-density polyethylene. When the polyethylene is a high-density polyethylene, the hardness of the sheath layer can be further increased, and thus the optical cable can have a further improved air-blowing performance into a microduct.

### Details of Embodiments of Present Disclosure

Hereinafter, an optical cable according to an embodiment of the present disclosure will be described in detail with reference to the drawings.

### <Optical Cable>

The optical cable is an optical cable for installation in a microduct and is an optical cable in which 10,000 optical-fiber core wires or less are loaded. The optical cable is installed mainly by air blowing in underground piping called a microduct. The optical cable includes optical-fiber core wires and sheath layers covering outer peripheries of the optical-fiber core wires. In addition, the optical cable includes an assembled core containing one or more optical-fiber core wires and a sheath layer covering an outer periphery of the assembled core.

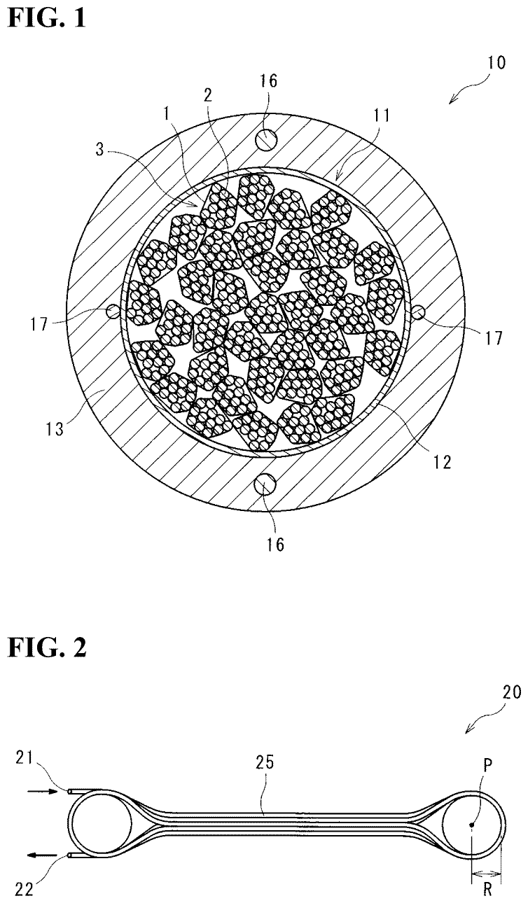

FIG. 1 is a schematic sectional view of an optical cable according to an embodiment of the present disclosure. As illustrated in FIG. 1, an optical cable 10 is a slot-less optical cable and includes, for example, when viewed in cross section, a circular assembled core 11, a sheath layer 13 covering assembled core 11, and tension members 16 and ripcords 17 embedded in sheath layer 13. It is noted that, the circular shape described herein does not mean a circle in a strict sense, but means a shape having a width in a range in which the effect of the present disclosure is obtained as long as the shape is in a range regarded as a circle. The above meaning of circular shape applies to all “circular shapes” in the present disclosure.

Assembled core 11 of optical cable 10 contains a plurality of fiber ribbons 3 that are gathered with a water swellable tape 12 in a circular shape when viewed in cross section. Each of fiber ribbons 3 has, for example, twelve optical-fiber core wires 2. The assembled core 11 may contain, in addition to fiber ribbons 3, a plurality of optical-fiber core wires 2 in a bundled state, the optical-fiber core wires each being a single-core optical-fiber core wire 2.

The outer surface of water swellable tape 12 is covered with sheath layer 13. In sheath layer 13, for example, two tension members 6 for maintaining the strength in a longitudinal direction and, for example, two ripcords 17 for ripping sheath layer 13 in the longitudinal direction of the cable are embedded so as to extend longitudinally when sheath layer 13 is extruded.

### [Fiber Ribbon]

Fiber ribbons 3 are each formed of, for example, a bundle of a plurality of optical-fiber core wires 2 covered with a tape 1 made of a polyester or the like. Publicly known optical fibers can be used as optical-fiber core wires 2. A plurality of fiber ribbons 3 may be intertwined into a unit to contain a plurality of units in an assembled state. In order to mount fiber ribbons 3 in assembled core 11 at a high density, fiber ribbons 3 may be, for example, intermittently connected fiber ribbons (hereinafter, also referred to as “intermittently adhered fiber ribbons”). The plurality of fiber ribbons 3 in the assembled state may be bundled with, for example, a bundle material or may be bundled with, for example, a bundle material for each of the units. In this embodiment, fiber ribbons 3 are contained in assembled core 11. Alternatively, optical-fiber core wires 2 may be contained in assembled core 11 in the form of an optical-fiber core wire 2 including a single core instead of the form of a fiber ribbon 3.

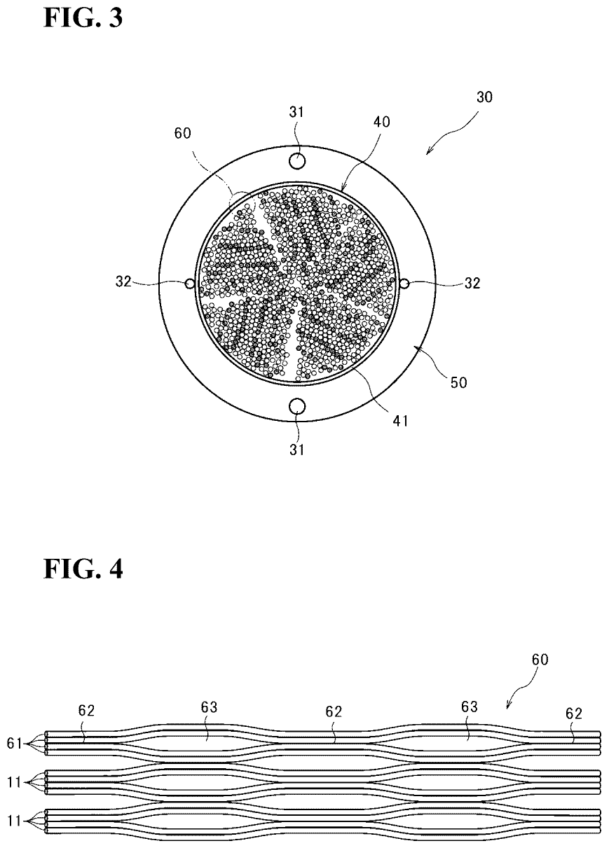

As described above, each of fiber ribbons 3 may be an intermittently adhered optical fiber ribbon contained in an optical cable. An optical cable 30 illustrated in FIG. 3 is a slotless optical cable, and includes, for example, a round assembled core 40 and a sheath layer (hereinafter, also referred to as a “cable jacket”) 50 formed around assembled core (hereinafter, also referred to as a “cable core”) 40. Cable core 40 contains 1,800 cores formed by, for example, using 150 pieces of intermittently adhered optical fiber ribbons (hereinafter, also referred to as “intermittent fiber ribbons”) 60 including 12 cores. In the illustrated example, 30 pieces of intermittent fiber ribbons 60 are bundled together with a rough winding string (figure not shown) or the like to form a unit, and five units thereof are formed.

As illustrated in FIG. 4, intermittent fiber ribbon 60 is formed by arranging a plurality of optical-fiber core wires 61 in a parallel row and intermittently connecting adjacent optical-fiber core wires by a connecting portion 62 and a non-connecting portion 63. Specifically, an example illustrated in FIG. 4 illustrates a state in which intermittent fiber ribbon 60 is opened in an arrangement direction, and intermittent fiber ribbon 60 is configured by arranging optical-fiber core wires 61 including 12 cores in a parallel row and by allowing every two cores to intermittently adhere to each other. Intermittent fiber ribbon 60 may not be provided with connecting portion 62 and non-connecting portion 63 for every two cores, and, for example, may be intermittently connected by connecting portion 62 and non-connecting portion 63 for each core.

Optical-fiber core wire 61 arranged as intermittent fiber ribbon 60 is formed by further applying colored coating to an outer surface of a primary coated fiber in which a glass fiber having a standard outer diameter of 125 μm is coated with a coating outer diameter of about 250 μm. Optical-fiber core wire 61 is not limited thereto, and may be a small-diameter fiber having a coating outer diameter in a range of 135 μm to 220 μm, for example, approximately 165 μm or 200 μm. High-density mounting becomes much easier by using the small-diameter fiber.

As illustrated in FIG. 3, for example, cable core 40 is formed in a round shape by longitudinally wrapping or spirally wrapping five units obtained by bundling 30 pieces of intermittent fiber ribbons 60 with a wrapping tape (hereinafter, also referred to as a “water swellable tape”) 41. The respective units have a structure stranded in one direction or by SZ-stranding. Here, intermittent fiber ribbons 60 can be freely deformed in cable core 40, which is effective for achieving high density. For the intermittent fiber ribbons, the entire contents described in Japanese Patent Application No. 2018-209242 are incorporated by reference.

### [Water Swellable Tape]

Water swellable tape 12 is wound around the entirety of the plurality of fiber ribbons 3 so as to extend longitudinally or spirally, for example. Water swellable tape 12 is produced by, for example, causing a water absorbing powder to adhere to a base cloth made of a polyester or the like to perform water-absorbent finishing.

### [Ripcord]

Ripcords 17 are cords for ripping sheath layer 13 and are embedded in sheath layer 13 in the longitudinal direction of optical cable 10. In this example, two ripcords 17 are provided. Two ripcords 17 are disposed at substantially intermediate positions between adjacent tension members 16 so as to face each other. By pulling out ripcords 17, sheath layer 13 can be ripped in the longitudinal direction to take out fiber ribbons 3. Ripcords 17 are formed of, for example, a plastic material (for example, polyester) having a high tensile strength.

### [Tension Member]

Optical cable 10 includes two tension members 16 that bear a tension in order to prevent elongation due to the self-weight during installation. Tension members 16 are disposed in sheath layer 13 in the longitudinal direction of optical cable 10. Tension members 16 are formed of wire materials having resistance to tension and compression, for example, steel wires or fiber reinforced plastics (FRP). Tension members 16 are each formed to have a circular shape in sectional view.

One ripcord 17 is provided on each side of assembled core 11 at a position on a line orthogonal to a line connecting the centers of two tension members 16. Ripcords 17 are string-like members having a circular shape in cross section and made of a resin material such as polyamide (e.g., nylon) or polyester. Ripcords 17 are arranged, for example, on the same straight line along a radial direction of assembled core 11.

### [Sheath Layer]

Sheath layer 13 is a resin layer covering the outer periphery of optical-fiber core wires 2. A main component of sheath layer 13 is polyethylene, and contains silicone.

The upper limit of a density of sheath layer 13 may be 1.0 g/cm³ or may be 0.96 g/cm³. When the density of sheath layer 13 is 1.0 g/cm³ or less, the weight can be reduced, and thus the blowing distance can be increased in the microduct.

The lower limit of an elastic modulus E1 of sheath layer 13 at 25° C. may be 250 MPa or may be 350 MPa. The upper limit of the elastic modulus E1 of sheath layer 13 at 25° C. may be 2,000 MPa or may be 1,850 MPa. When the elastic modulus E1 of sheath layer 13 at 25° C. is less than 250 MPa, sheath layer 13 cannot have a sufficient hardness, and the air-blowing performance into the microduct may be reduced. When the elastic modulus E1 of sheath layer 13 at 25° C. exceeds 2,000 MPa, the flexibility at room temperature is reduced, and the sheath layer may be cracked during installation.

The lower limit of an elastic modulus E2 of sheath layer 13 at 70° C. may be 30 MPa or may be 40 MPa. When the elastic modulus E2 of sheath layer 13 at 70° C. is less than 30 MPa, sheath layer 13 may be deformed during storage at a high temperature. The upper limit of the elastic modulus E2 of sheath layer 13 at 70° C. is not particularly limited.

The lower limit of an elastic modulus E3 of sheath layer 13 at −30° C. may be 500 MPa or may be 1,000 MPa. The upper limit of the elastic modulus E3 of sheath layer 13 may be 5,000 MPa or 4,000 MPa. When the elastic modulus E3 of sheath layer 13 is less than 500 MPa, the lateral pressure resistance at a low temperature may be insufficient. When the elastic modulus E3 of sheath layer 13 exceeds 5,000 MPa, the flexibility at a low temperature is reduced, and sheath layer 13 may be cracked during installation.

The upper limit of a product C1×E3 of a linear expansion coefficient C1 of sheath layer 13 in a temperature range of −30° C. to 70° C. and the elastic modulus E3 of sheath layer 13 at −30° C. may be 0.35 [MPa/K] or may be 0.25 [MPa/K]. In the optical cable, the product of the linear expansion coefficient of sheath layer 13 and the elastic modulus of sheath layer 13 at a low temperature is set to the above range, and thus it is possible to improve the effect of suppressing an increase in transmission loss due to expansion and contraction of the sheath layer after heat cycles. A value of the product C1×E3 can be adjusted by the type, content ratio and the like of olefin-based resin.

An average thickness of sheath layer 13 is appropriately determined based on the size, use, and the like of the cable. The lower limit of the average thickness of sheath layer 13 may be 0.05 mm, 0.5 mm, or 1.0 mm. The upper limit of the average thickness of sheath layer 13 may be 10 mm, 8 mm, or 5 mm. When the average thickness of sheath layer 13 is less than 0.05 mm, wear resistance may be insufficient. When the average thickness of sheath layer 13 exceeds 10 mm, it may not be possible to save space on routing the cable. The “average” in the “average thickness” refers to an average value of thicknesses measured at any three points.

### (Polyethylene)

Sheath layer 13 contains polyethylene as a main component. Examples of the polyethylene include a high-density polyethylene (HDPE), a low-density polyethylene (LDPE), and a linear low-density polyethylene (LLDPE). The polyethylene may be a high-density polyethylene. When the polyethylene is a high-density polyethylene, the hardness of the sheath layer can be further increased, and thus optical cable 10 easily passes through a microduct.

The lower limit of a density of the polyethylene may be 0.92 g/cm³ or may be 0.94 g/cm³. The upper limit of the density of the polyethylene may be 0.98 g/cm³ or may be 0.96 g/cm³. When the density of sheath layer 13 is less than 0.92 g/cm³, sheath layer 13 may have an insufficient hardness, and thus air-blowing performance into a microduct may be reduced. When the density of sheath layer 13 exceeds 0.98 g/cm³, the weight of sheath layer 13 cannot be reduced, and thus the air-blowing performance into the microduct may be reduced. The density of the low-density polyethylene is less than 0.94 g/cm³, and the density of the high-density polyethylene is 0.94 g/cm³ or greater.

The lower limit of a content ratio of the polyethylene in sheath layer 13 may be 90% by mass or may be 92% by mass. The upper limit of the content ratio of the polyethylene in the resin component may be 99.5% by mass or may be 98% by mass. When the content ratio of the polyethylene is less than 90% by mass, sheath layer 13 may have an insufficient hardness, and thus air-blowing performance into the microduct may be reduced. When the content ratio of the polyethylene exceeds 99.5% by mass, it may be difficult to improve the slidability of sheath layer 13 generated by silicone.

### (Silicone)

Sheath layer 13 contains a silicone as a lubricant. When sheath layer 13 contains a silicone, the coefficient of friction of sheath layer 13 can be lowered to improve slidability. Thus, when optical cable 10 is blown with air in a microduct, the friction between sheath layer 13 and the microduct can be reduced to increase the blowing distance of optical cable 10.

The lower limit of a weight-average molecular weight of the silicone may be 50,000 or may be 70,000. The upper limit of the weight-average molecular weight of the silicone may be 1,000,000 or may be 800,000. When the weight-average molecular weight of the silicone is less than 50,000, sheath layer 13 may have an insufficient surface slidability, and thus air-blowing performance into the microduct may be reduced. When the weight-average molecular weight of the silicone exceeds 1,000,000, compatibility with the resin component may be reduced.

The lower limit of a content ratio of the silicone in sheath layer 13 may be 0.5% by mass or 1% by mass. The upper limit of the content ratio of the silicone in sheath layer 13 may be 10% by mass or 8%. When the content ratio of the silicone in sheath layer 13 is less than 0.5% by mass, sheath layer 13 may have an insufficient surface slidability, and thus the air-blowing performance into the microduct may be reduced. When the content ratio of the silicone in sheath layer 13 exceeds 10% by mass, the compatibility with the resin component may be reduced.

### [Method of Manufacturing Optical Cable]

Next, an example of a method of manufacturing optical cable 10 will be described. The method of manufacturing optical cable 10 includes, for example, a step of preparing fiber ribbon 3; and a step of covering an outer periphery of fiber ribbon 3 with sheath layer 13.

In the step of preparing fiber ribbon 3 (fiber ribbon preparation step), a plurality of optical-fiber core wires 2 are wrapped with a tape to assemble the optical-fiber core wires 2.

In the step of covering with a sheath layer 13, an outer periphery of one fiber ribbon 3 or an assembly of a plurality of fiber ribbons 3 obtained in the step of preparing fiber ribbon 3 is covered with sheath layer 13. An example of the covering method used is extrusion molding of a resin composition for forming a sheath layer containing polyethylene as a main component and silicone.

According to optical cable 10, sheath layer 13 is reduced in weight, and the hardness and the surface slidability are adjusted to be in a favorable range. Thus, optical cable 10 is excellent in air-blowing performance into the microduct.

### Other Embodiments

It is to be understood that the embodiments disclosed herein are only illustrative and non-restrictive in all respects. The scope of the present disclosure is not limited to the configurations of the embodiments but is defined by the appended claims, and is intended to include all modifications within the scope and meaning equivalent to the scope of the claims.

### Example

Hereinafter, the present disclosure will be more specifically described by way of Examples. However, the present disclosure is not limited to the following Examples

### <Optical Cables No. 1 to No. 15>

### (1) Preparation of Sheath Layer

Resin compositions for forming sheath layers were prepared at blend ratios shown in Table 1, and tubular sheath layers of No. 1 to No. 15 having an average outer diameter of 12.0 mm and an average thickness of 1.5 mm were formed by extruding the resin compositions for forming sheath layers. The compositions and densities of the resin compositions for forming sheath layers are shown in Table 1. The symbol “-” indicates that the corresponding component is not used.

### (Polyethylene)

In Table 1, the polyethylene used is as follows.
(1) HDPE 1 (high-density polyethylene)
“HI-ZEX 5100E” manufactured by Prime Polymer Co., Ltd.
Density 0.94 g/cm³
(2) HDPE 2 (high-density polyethylene)
“HI-ZEX 5000H” manufactured by Prime Polymer Co., Ltd.
Density 0.96 g/cm³
(3) LLDPE (low-density polyethylene)
“NUCG9121” manufactured by ENEOS NUC Corporation.
Density 0.92 g/cm³
(4) VLDPE (very-low-density polyethylene)
“TAFMER DF110” manufactured by Mitsui Chemicals, Inc.
Density 0.90 g/cm³

### (Lubricant)

(1) High-molecular-weight silicone 1
Weight-average molecular weight 659,000
(2) High-molecular-weight silicone 2
Weight-average molecular weight 71,500
(3) High-molecular-weight silicone 3
Weight-average molecular weight 38,500

### [Evaluation]

The sheath layers and the optical cables of No. 1 to No. 15 were evaluated for the following items.

### (Elastic Modulus)

With regard to the sheath layers of the optical cables of No. 1 to No. 15, an elastic modulus E1 at −25° C., an elastic modulus E2 at 70° C., and an elastic modulus E3 at −30° C. were determined, in accordance with the test method of dynamic mechanical properties described in JIS-K7244-4 (1999), from storage elastic moduli measured with a viscoelasticity measuring device (“DVA-220” manufactured by IT Keisoku Seigyo Co., Ltd.) in a tensile mode, in a temperature range of from −60° C. to 80° C., at a temperature increasing rate of 5° C./min, at a frequency of 10 Hz, and at a strain of 0.05%. The results are shown in Table 1.

### (Linear Expansion Coefficient, and Product of Linear Expansion Coefficient and Elastic Modulus at −30° C.)

In accordance with the test method for dynamic mechanical properties described in JIS-K7244-4 (1999), a linear expansion coefficient C1 in a temperature range of −30° C. to 70° C. was calculated from a dimensional change of a thin sheet with respect to a temperature change using a viscoelasticity measuring device (“DVA-220” manufactured by IT Keisoku Seigyo Co., Ltd.) in a tensile mode, in a temperature range of −60° C. to 80° C., at a temperature increasing rate of 5° C./min, at a frequency 10 Hz, and at a strain of 0.05%. Furthermore, the product C1×E3 of the linear expansion coefficient C1 in the temperature range of −30° C. to 70° C. and the elastic modulus E3 at −30° C. was calculated.

### (Coefficient of Kinetic Friction)

Coefficients of kinetic friction of the sheath layers were measured by the following procedure. First, sheath layers were prepared by extrusion using only sheath materials. Thereafter, the coefficients of friction of the sheath layers prepared above were measured in accordance with JIS-K7125:1999. When the coefficient of kinetic friction is 0.35 or less, the surface of the sheath layer has a good slidability, and thus the air-blowing property of the optical cable can be further improved.

### (Air-Blowing Property of Optical Cable)

A blowing distance of each of the optical cables of No. 1 to No. 15 was determined by conducting a microduct blowing test based on the International Electrotechnical Commission (IEC) standard using a blowing equipment 20 illustrated in FIG. 2. A pipe 25 has a total length of 1,000 m and folded back at every 100 m. A radius of curvature R (a radius of the circle of curvature centered at P) of each curved portion in the fold of pipe 25 is 40 times the outer diameter of pipe 25. The inner diameter of pipe 25 is 14 mm. Air and each optical cable were fed from an inlet port 21 of pipe 25 and taken out from an outlet port 22. The pressure of the air was 1.3 MPa to 1.5 MPa. The air-blowing property of the optical cable was evaluated at two levels, A and B, based on the blowing distance of the optical cable. The evaluation criteria for the air-blowing property of the optical cable were as follows.
A: Good: Blowing distance is 1,000 m or more.
B: Poor: Blowing distance is less than 1,000 m.

### (Presence of Die Lip Buildup)

The presence of die lip buildup, which is an indicator of production efficiency, was evaluated by the following procedure. In the extrusion molding, the presence of die lip buildup accumulated at a die after 500 m extrusion were visually checked. When the die lip buildup accumulates at the die during extrusion molding and the process continues, the die lip buildup may adhere to a heat-recoverable article, potentially causing a defect. Thus, it is necessary to interrupt the extrusion molding and remove the die lip buildup. The presence of the die lip buildup was evaluated at two levels, A and B. The evaluation criteria for the presence of the die lip buildup were as follows.
A: Good: No die lip buildup is accumulated at the die, and extrusion molding can be continued.
B: Poor: Die lip buildup is accumulated at the die, and interruption of extrusion molding and removal of the die lip buildup are necessary.

The evaluation results are shown in Table 1.

TABLE 1

| Example No. | | | | 1 | 2 | 3 | 4 | 5 | 6 | 7 | 8 |
|---|---|---|---|---|---|---|---|---|---|---|---|
| Sheath | Polyethylene | HDPE1 | Density0.94 [g/cm³] | 99.5 | 90.0 | — | — | — | — | 99.5 | 90.0 |
| layer | (mass %) | HDPE2 | Density0.96 [g/cm³] | — | — | 99.5 | 90.0 | — | — | — | — |
| composition | | LLDPE | Density0.92 [g/cm³] | — | — | — | — | 99.5 | 90.0 | — | — |
| | | VLDPE | Density0.90 [g/cm³] | — | — | — | — | — | — | — | — |

| | | | | | | | | | |
|---|---|---|---|---|---|---|---|---|---|
| Silicone | High-molecular-weight silicone | 0.5 | 10.0 | 0.5 | 10.0 | 0.5 | 10.0 | — | — |
| (mass %) | (Weight-average molecular weight 659000) | | | | | | | | |
| | High-molecular-weight silicone | — | — | — | — | — | — | 0.5 | 10.0 |
| | (Weight-average molecular weight 71500) | | | | | | | | |
| | High-molecular-weight silicone | — | — | — | — | — | — | — | — |
| | (Weight-average molecular weight 38500) | | | | | | | | |

| | | | | | | | | | | |
|---|---|---|---|---|---|---|---|---|---|---|
| Evaluation | Elastic modulus | 25° C.: E1 | 1440 | 1320 | 1820 | 1795 | 395 | 351 | 1415 | 1280 |
| | [MPa] | 70° C.: E2 | 60 | 52 | 78 | 68 | 35 | 31 | 58 | 51 |

| | | | | | | | | |
|---|---|---|---|---|---|---|---|---|
| −30° C.: E3 | 2493 | 2410 | 3105 | 2986 | 1836 | 1627 | 2430 | 2328 |

| | | | | | | | | |
|---|---|---|---|---|---|---|---|---|
| Linear expansion coefficient (−30° C. ~70° C.): C1 | 124 | 121 | 105 | 106 | 184 | 186 | 118 | 120 |
| [10⁻⁶/K] | | | | | | | | |
| Product of linear expansion coefficient | 0.31 | 0.29 | 0.33 | 0.32 | 0.34 | 0.30 | 0.29 | 0.28 |
| and elastic modulus (at −30° C.) | | | | | | | | |
| C1 × E3 [Mpa/K] | | | | | | | | |
| Density of sheath layer [g/cm³] | 0.94 | 0.94 | 0.96 | 0.96 | 0.92 | 0.93 | 0.94 | 0.94 |
| Coefficient of kinetic friction | 0.29 | 0.15 | 0.25 | 0.13 | 0.32 | 0.16 | 0.26 | 0.11 |
| Air-blowing property of optical cable | A | A | A | A | A | A | A | A |
| Presence of die lip buildup | A | A | A | A | A | A | A | A |

| Example No. | | | | 9 | 10 | 11 | 12 | 13 | 14 | 15 |
|---|---|---|---|---|---|---|---|---|---|---|
| Sheath | Polyethylene | HDPE1 | Density0.94 [g/cm³] | 100.0 | 99.5 | 90.0 | — | — | 85.0 | 99.8 |
| layer | (mass %) | HDPE2 | Density0.96 [g/cm³] | — | — | — | — | — | — | — |
| composition | | LLDPE | Density0.92 [g/cm³] | — | — | — | — | — | — | — |
| | | VLDPE | Density0.90 [g/cm³] | — | — | — | 99.5 | 90.0 | — | — |

| | | | | | | | | |
|---|---|---|---|---|---|---|---|---|
| Silicone | High-molecular-weight silicone | — | — | — | 0.5 | 10.0 | 15.0 | 0.2 |
| (mass %) | (Weight-average molecular weight 659000) | | | | | | | |
| | High-molecular-weight silicone | — | — | — | — | — | — | — |
| | (Weight-average molecular weight 71500) | | | | | | | |
| | High-molecular-weight silicone | — | 0.5 | 10.0 | — | — | — | — |
| | (Weight-average molecular weight 38500) | | | | | | | |

| | | | | | | | | | |
|---|---|---|---|---|---|---|---|---|---|
| Evaluation | Elastic modulus | 25° C.: E1 | 1451 | 1402 | 1262 | 128 | 121 | 1282 | 1430 |
| | [MPa] | 70° C.: E2 | 60 | 58 | 51 | 8 | 6 | 48 | 60 |

| | | | | | | | |
|---|---|---|---|---|---|---|---|
| −30° C.: E3 | 2520 | 2395 | 2288 | 837 | 820 | 2259 | 2520 |

| | | | | | | | |
|---|---|---|---|---|---|---|---|
| Linear expansion coefficient (−30° C. ~70° C.): C1 | 120 | 121 | 115 | 192 | 190 | 120 | 125 |
| [10⁻⁶/K] | | | | | | | |
| Product of linear expansion coefficient | 0.30 | 0.29 | 0.26 | 0.16 | 0.16 | 0.27 | 0.32 |
| and elastic modulus (at −30° C.) | | | | | | | |
| C1 × E3 [Mpa/K] | | | | | | | |
| Density of sheath layer [g/cm³] | 0.94 | 0.94 | 0.94 | 0.90 | 0.91 | 0.95 | 0.94 |
| Coefficient of kinetic friction | 0.38 | 0.26 | 0.12 | 0.35 | 0.22 | 0.11 | 0.36 |
| Air-blowing property of optical cable | B | A | A | B | B | A | B |
| Presence of die lip buildup | A | B | B | A | A | B | A |

As shown in Table 1, each of No. 1 to No. 8 in which the sheath layer had a density of 1.0 g/cm³ or less, the sheath layer contained polyethylene as a main component and silicone, the polyethylene had a density of 0.92 g/cm³ or greater, the silicone had a weight-average molecular weight of 50,000 to 1,000,000, and the content ratio of the silicone in the sheath layer was 0.5% by mass to 10% by mass had a low coefficient of kinetic friction, and a good air-blowing property and productivity of the optical cable.

On the other hand, No. 9 in which the sheath layer did not contain silicone had a higher coefficient of kinetic friction and an inferior air-blowing property of the optical cable. In No. 10 and No. 11 in which the silicone had a weight-average molecular weight of less than 50,000, die lip buildup was generated. No. 12 and No. 13 in which the polyethylene has a density of less than 0.92 g/cm³ had an inferior air-blowing property of the optical cables. In No. 14 in which the content ratio of the silicone in the sheath layer exceeded 10% by mass, die lip buildup was generated. No. 15 in which the content ratio of silicone in the sheath layer was less than 0.5% by mass had a high coefficient of kinetic friction and an inferior air-blowing property of the optical cable.

The above results showed that the optical cables had good air-blowing performances into the microducts due to improvements in the hardness of the sheath layer, the slidability of the surface of the sheath layer, and the reduction in weight of the sheath layer. The optical cables can be suitable for use as, for example, optical cables for microducts between data centers in which a high volume of information is transmitted.

### REFERENCE SIGNS LIST

1 tape
2, 61 optical-fiber core wire
3 fiber ribbon
10, 30 optical cable
11, 40 assembled core (cable core)
12, 41 water swellable tape (wrapping tape)
13, 50 sheath layer (cable jacket)
16, 31 tension member
17, 32 ripcord
20 blowing equipment
21 inlet port
22 outlet port
25 pipe
60 intermittent fiber ribbon
62 connecting portion
63 non-connecting portion

What is claimed is:

1. An optical cable for installation in a microduct, the optical cable comprising:
an assembled core containing one or more optical-fiber core wires; and
a sheath layer covering an outer periphery of the assembled core,
wherein the sheath layer has a density of 1.0 g/cm³ or less,
a main component of the sheath layer is polyethylene,
the sheath layer contains silicone,
the polyethylene has a density of 0.92 g/cm³ or greater,
the silicone has a weight-average molecular weight of 50,000 to 1,000,000, and
a content ratio of the silicone in the sheath layer is 0.5% by mass to 10% by mass.

2. The optical cable according to claim 1, wherein the assembled core contains the one or more optical-fiber core wires in a state of being bundled by a water swellable tape.

3. The optical cable according to claim 2, wherein the assembled core contains the one or more optical-fiber core wires in a state of being bundled into a circular shape in a cross-sectional view by the water swellable tape.

4. The optical cable according to claim 1, wherein the one or more optical-fiber core wires are each an intermittently adhered optical fiber ribbon.

5. The optical cable according to claim 1, wherein the sheath layer has an elastic modulus E1 of 250 MPa to 2,000 MPa at 25° C.

6. The optical cable according to claim 1, wherein the sheath layer has an elastic modulus E2 of 30 MPa or greater at 70° C.

7. The optical cable according to claim 1, wherein a product C1×E3 of a linear expansion coefficient C1 of the sheath layer in a temperature range of −30° C. to 70° C. and an elastic modulus E3 of the sheath layer at −30° C. is 0.35 [MPa/K] or less.

8. The optical cable according to claim 1, wherein the polyethylene is a high-density polyethylene.

9. The optical cable according to claim 2, wherein the one or more optical-fiber core wires are each an intermittently adhered optical fiber ribbon.

10. The optical cable according to claim 3, wherein the one or more optical-fiber core wires are each an intermittently adhered optical fiber ribbon.

11. The optical cable according to claim 2, wherein the sheath layer has an elastic modulus E1 of 250 MPa to 2,000 MPa at 25° C.

12. The optical cable according to claim 3, wherein the sheath layer has an elastic modulus E1 of 250 MPa to 2,000 MPa at 25° C.

13. The optical cable according to claim 4, wherein the sheath layer has an elastic modulus E1 of 250 MPa to 2,000 MPa at 25° C.

14. The optical cable according to claim 2, wherein the sheath layer has an elastic modulus E2 of 30 MPa or greater at 70° C.

15. The optical cable according to claim 3, wherein the sheath layer has an elastic modulus E2 of 30 MPa or greater at 70° C.

16. The optical cable according to claim 4, wherein the sheath layer has an elastic modulus E2 of 30 MPa or greater at 70° C.

17. The optical cable according to claim 5, wherein the sheath layer has an elastic modulus E2 of 30 MPa or greater at 70° C.

18. The optical cable according to claim 2, wherein a product C1×E3 of a linear expansion coefficient C1 of the sheath layer in a temperature range of −30° C. to 70° C. and an elastic modulus E3 of the sheath layer at −30° C. is 0.35 [MPa/K] or less.

19. The optical cable according to claim 3, wherein a product C1×E3 of a linear expansion coefficient C1 of the sheath layer in a temperature range of −30° C. to 70° C. and an elastic modulus E3 of the sheath layer at −30° C. is 0.35 [MPa/K] or less.

20. The optical cable according to claim 4, wherein a product C1×E3 of a linear expansion coefficient C1 of the sheath layer in a temperature range of −30° C. to 70° C. and an elastic modulus E3 of the sheath layer at −30° C. is 0.35 [MPa/K] or less.
